(19) United States
(12) Patent Application Publication
(10) Pub. No.: US 2008/0175025 A1
(43) Pub. Date: Jul. 24, 2008

(54) DC-DC converter and method in wireless communication system

(75) Inventor: Hyun-Su Yoon, Gyeonggi-do (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/009,840

(22) Filed: Jan. 21, 2008

(30) Foreign Application Priority Data
Jan. 19, 2007 (KR) 2007-0005922

(51) Int. Cl. H02M 3/00; G05F 5/00

(52) U.S. Cl. 363/15; 323/299

(57) ABSTRACT

A Direct Current (DC)-DC converter and method in a wireless communication system are provided. The converter includes a mode determiner, a DC-DC module, and a bypass module. The mode determiner controls operation of the DC-DC module depending on a magnitude of an input voltage. When the DC-DC module is activated by the mode determiner, the DC-DC module steps up the input voltage to a reference voltage and provides the step-up voltage to a corresponding electronic device. When the DC-DC module is inactivated by the mode determiner, the bypass module passes the input voltage to the electronic device.

### CROSS-REFERENCE TO RELATED APPLICATION(S) AND CLAIM OF PRIORITY

This application claims priority under 35 U.S.C. §119(a) to a Korean Patent Application filed in the Korean Intellectual Property Office on Jan. 19, 2007 and assigned Serial No. 2007-5922, the contents of which are herein incorporated by reference.

### TECHNICAL FIELD OF THE INVENTION

The present invention relates generally to a Direct Current (DC)-DC converter and method in a wireless communication system, and in particular, to a DC-DC converter and method for reducing a range of voltage converted by the DC-DC converter in a wireless communication system.

### BACKGROUND OF THE INVENTION

Electronic devices all operate using DC voltages as internal operation power sources. Thus, after converting Alternating Current (AC) input voltages into DC voltages, the electronic devices generate DC driving voltages desired by the electronic devices using DC-DC converters and use the generated DC driving voltages.

Because a wireless communication system comprising electronic devices using different DC driving voltages, the wireless communication system uses a diversity of DC-DC converters to achieve a stable operation for each of the electronic devices.

The DC-DC converter is based on a Switching Mode Power Supply (SMPS) technology. That is, the DC-DC converter supplies a voltage desired by each electronic device using a switching technology and a transformer. Construction of the DC-DC converter is shown in FIG. 1 as follows.

FIG. 1 is a block diagram illustrating a construction of a DC-DC converter in a wireless communication system according to the conventional art.

As shown in FIG. 1, the DC-DC converter 100 includes an input filter 101, a transformer 103, an output rectifier and filter 105, an output voltage detector 107, a DC-DC converter controller 109, and a pulse width modulator 111.

The input filter 101 filters a voltage received via an input terminal (Vin) to prevent an unnecessary electronic wave caused by high frequency switching from being radiated to the transformer 103.

The transformer 103 applies the input voltage received from the input filter 101 to a primary coil under the control of the pulse width modulator 111. The input voltage applied to the primary coil is applied as energy of a secondary coil through a core. That is, under the control of the pulse width modulator 111, the transformer 103 adjusts a time for which the input voltage is applied to the primary coil, thereby controlling a magnitude of an output voltage.

The pulse width modulator 111 switches and applies the input voltage to the primary coil of the transformer 103 depending on a square wave received from the DC-DC converter controller 109.

The DC-DC converter controller 109 includes an internal oscillation circuit and outputs a square wave for controlling the pulse width modulator 111 at a frequency outputted from the internal oscillation circuit. The DC-DC converter controller 109 changes the frequency of the internal oscillation circuit such that the transformer 103 can output a stable voltage depending on a magnitude of an output voltage provided from the output voltage detector 107. For instance, when the output voltage identified in the output voltage detector 107 is a low voltage, the DC-DC converter controller 109 changes a frequency to increase a time for which the input voltage is applied to the primary coil of the transformer 103. When the output voltage identified in the output voltage detector 107 is a high voltage, the DC-DC converter controller 109 changes the frequency to decrease the time for which the input voltage is applied to the primary coil of the transformer 103.

The output rectifier and filter 105 includes a diode and a capacitor and generates a DC voltage using energy received from the transformer 103. In detail, the output rectifier and filter 105 rectifies, by the diode, the energy received from the secondary coil of the transformer 103. After that, the output rectifier and filter 105 smoothes, by the capacitor, the voltage rectified by the diode and generates the DC voltage.

The output voltage detector 107 detects a voltage output by the output rectifier and filter 105 and provides the detected output voltage to the DC-DC converter controller 109.

The above-constructed DC-DC converter converts an input voltage into an optimum voltage at which an operation characteristic of a specific electronic device is optimized and provides the converted voltage to the electronic device.

The wireless communication system provides a predetermined range of voltage to electronic devices that are system constituents to operate the electronic devices normally.

In order to provide an optimum voltage at which an operation characteristic is optimized to electronic devices using different DC driving voltages, the wireless communication system converts a predetermined range of voltage suitably to an operation characteristic of each electronic device, using the DC-DC converter.

FIG. 2 is a diagram illustrating a range of operation voltage of a DC-DC converter in a wireless communication system according to the conventional art. Of electronic devices included in the wireless communication system, a Radio Frequency (RF) power amplifier is described below, as an example.

As shown in FIG. 2, the wireless communication system provides a norm voltage (Vnor) 210 to the RF power amplifier.

Since a supply voltage can temporarily vary depending on environmental change, the wireless communication system provides a predetermined range of voltage (Vnor.1 230 to Vnor.h 220) to the RF power amplifier so that the RF power amplifier can operate normally.

Thus, the RF power amplifier normally operates when receiving a voltage between the Vnor.1 230 and the Vnor.h 220, while the RF power amplifier generates a supply voltage fail alarm event when receiving a voltage lower than the Vnor.1 230 or higher than the Vnor.h 220.

If it is assumed that an operation characteristic of the RF power amplifier is optimized at a Vopt 200 between the Vnor.1 230 and the Vnor.h 220, the wireless communication system supplies the RF power amplifier with the Vopt 200 at which the operation characteristic is optimized, using the DC-DC converter.

In detail, the DC-DC converter converts an input voltage between the Vnor.1 230 and the Vnor.h 220 into the Vopt 200 and provides the Vopt 200 to the RF power amplifier to optimize the operation characteristic of the RF power amplifier. For instance, the DC-DC converter performs step-up when receiving a voltage lower than the Vopt 200 and performs step-down when receiving a voltage higher than the Vopt 200, thereby providing the Vopt 200 to the RF power amplifier.

As described above, the DC-DC converter converts an input voltage such that an operation characteristic of a specific electronic device is optimized. In detail, the DC-DC converter performs step-up when receiving a voltage lower than an optimum voltage at which an operation characteristic of a corresponding electronic device is optimized and performs step-down when receiving a voltage higher than the optimum voltage at which the operation characteristic of the electronic device is optimized, thereby providing the optimum voltage to the RF power amplifier.

Thus, the DC-DC converter has great influence on efficiency of the electronic device.

However, there is a drawback that a total efficiency of the DC-DC converter goes down and a cost goes up because the DC-DC converter should perform all of step-up and step-down for a wide range of voltage supplied to electronic devices in the wireless communication system.

### SUMMARY OF THE INVENTION

To address the above-discussed deficiencies of the prior art, it is a primary object of the present invention to substantially solve at least the above problems and/or disadvantages and to provide at least the advantages below. Accordingly, one aspect of the present invention is to provide a DC-DC converter and method for achieving efficiency improvement in a wireless communication system.

Another aspect of the present invention is to provide a DC-DC converter and method for achieving a reduction of a supply voltage range and efficiency improvement in a wireless communication system.

A further aspect of the present invention is to provide a DC-DC converter and method for passing a voltage higher than an optimal supply voltage and stepping up a voltage lower than the optimal supply voltage in a wireless communication system.

The above aspects are achieved by providing a DC-DC converter and method in a wireless communication system.

According to one aspect of the present invention, there is provided a DC-DC converter in a wireless communication system. The converter includes a mode determiner, a DC-DC module, and a bypass module. The mode determiner controls operation of the DC-DC module depending on a magnitude of an input voltage. When the DC-DC module is activated by the mode determiner, the DC-DC module steps up the input voltage to a reference voltage and provides the step-up voltage to a corresponding electronic device. When the DC-DC module is inactivated by the mode determiner, the bypass module passes the input voltage to the electronic device.

According to another aspect of the present invention, there is provided a DC-DC converter in a wireless communication system. The converter includes a mode determiner, a DC-DC module, and a bypass module. The mode determiner selects a path for transmitting an input voltage to an electronic device depending on a magnitude of the input voltage. Upon receiving an input voltage according to selection of the mode determiner, the DC-DC module steps up the input voltage to a reference voltage and provides the step-up input voltage to the electronic device. Upon receiving an input voltage according to selection of the mode determiner, the bypass module passes the input voltage to the electronic device.

According to a further aspect of the present invention, there is provided a DC-DC conversion method in a wireless communication system. The method includes determining whether to convert an input voltage depending on a magnitude of the input voltage; when the input voltage is converted, stepping up the input voltage to the reference voltage and providing the step-up input voltage to a corresponding electronic device; and when the input voltage is not converted, passing the input voltage to the electronic device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of a DC-DC converter in a wireless communication system according to the conventional art;

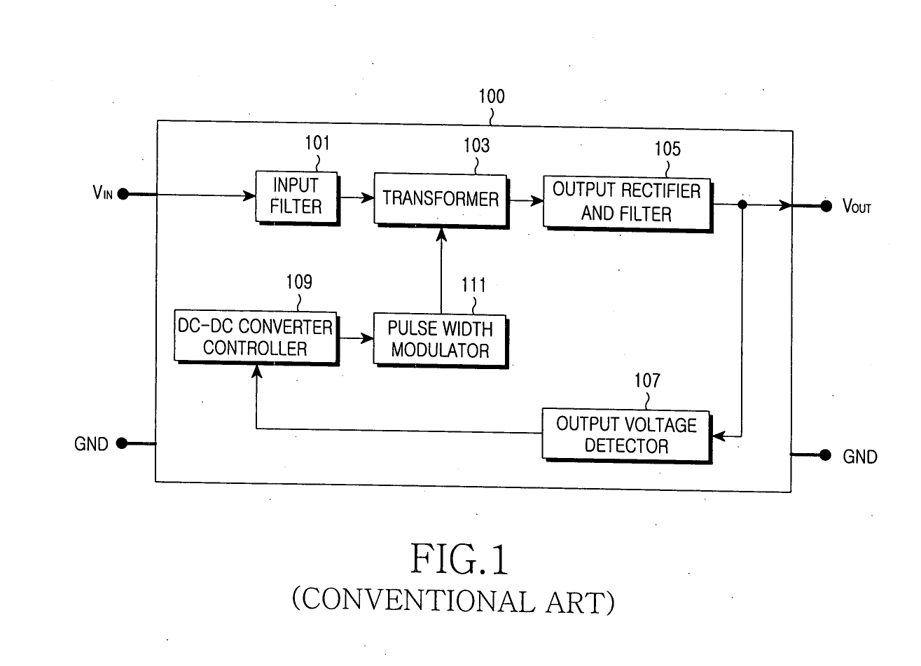

FIG. 2 is a diagram illustrating a range of an operation voltage of a DC-DC converter in a wireless communication system according to the conventional art;

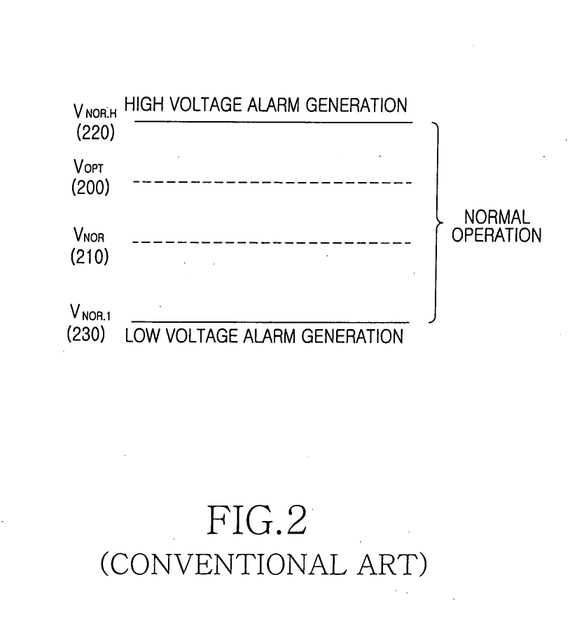

FIG. 3 is a block diagram illustrating a construction of a DC-DC converter in a wireless communication system according to the present invention; and

FIG. 4 is a flow diagram illustrating a process of DC-DC conversion in a wireless communication system according to an exemplary embodiment of the present invention.

### DETAILED DESCRIPTION OF THE INVENTION

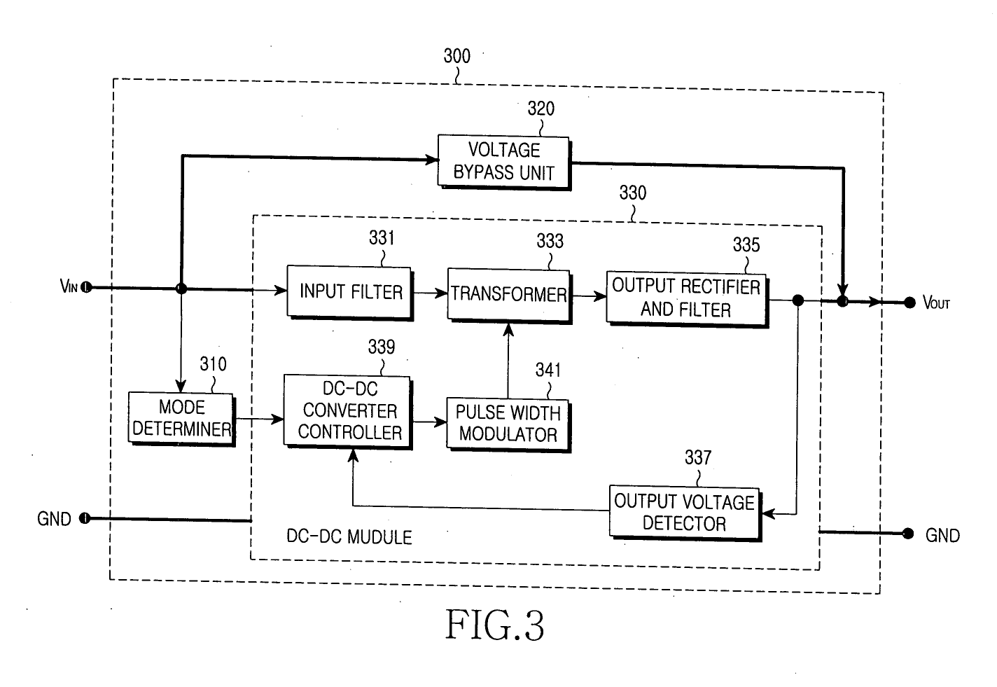

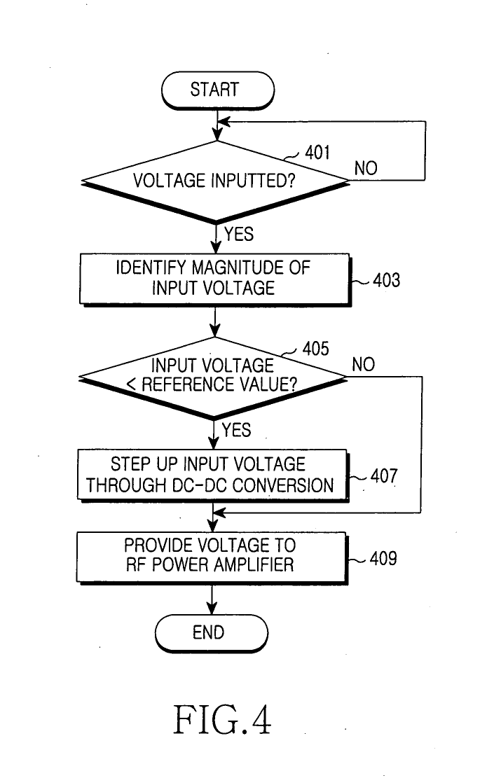

FIGS. 3 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged DC-DC converter for a wireless communication system.

The present invention provides a technology for improving efficiency of a DC-DC converter in a wireless communication system below.

In the following description, the wireless communication system reduces, by the DC-DC converter, a range of voltage converted by the DC-DC converter to optimize an operation characteristic of a corresponding electronic device, achieving efficiency improvement. Here, the wireless communication system can reduce the range of voltage converted by the DC-DC converter, using linear characteristics of electronic devices dependent on input voltages. In detail, the electronic devices constituting the wireless communication system get worse in linear characteristic when receiving a voltage lower than an optimum voltage at which an operation characteristic is optimized, while getting better in linear characteristic when receiving a voltage higher than the optimum voltage at which the operation characteristic is optimized. Thus, when receiving the input voltage lower than the optimum voltage at which the operation characteristic of the electronic device is optimized, the wireless communication system controls the DC-DC converter to step-up the lower input voltage. On the other hand, when receiving the input voltage higher than the optimum voltage at which the operation characteristic of the electronic device is optimized, the wireless communication system controls the DC-DC converter and passes the higher input voltage.

The following description is an example in which an input voltage of an RF power amplifier among electronic devices constituting a wireless communication system is converted using a DC-DC converter.

In order for the wireless communication system to reduce a range of voltage converted by the DC-DC converter to optimize an operation characteristic of the RF power amplifier, the DC-DC converter has a construction of FIG. 3 as follows.

FIG. 3 is a block diagram illustrating a construction of a DC-DC converter in a wireless communication system according to the present invention.

As shown in FIG. 3, the DC-DC converter 300 includes a mode determiner 310, a voltage bypass unit 320, and a DC-DC module 330.

The mode determiner 310 measures a magnitude of an input voltage received though an input terminal (Vin) and determines operation state or non-operation state of the DC-DC module 330. For example, if an input voltage is lower than a reference value, the mode determiner 310 activates the DC-DC module 330 to step up the input voltage to the reference voltage. On the other hand, if the input voltage is higher or equal to the reference value, the mode determiner 310 inactivates the DC-DC module 330 and directly passes the input voltage to the RF power amplifier. The reference value represents an optimum voltage at which an operation characteristic of the RF power amplifier is optimized.

The voltage bypass unit 320 passes the input voltage to the RF power amplifier when the input voltage is higher than the optimum voltage at which the operation characteristic of the RF power amplifier is optimized. The voltage bypass unit 320 is comprised of a diode and thus, prevents passing of a supply voltage lower than the optimum voltage.

Under the control of the mode determiner 310, the DC-DC module 330 operates when receiving an input voltage lower than the optimum voltage at which the operation characteristic of the RF power amplifier is optimized. Thus, the DC-DC module 330 performs operation for stepping up the lower input voltage.

The DC-DC module 330 includes an input filter 331, a transformer 333, an output rectifier and filter 335, an output voltage detector 337, a DC-DC converter controller 339, and a pulse width modulator 341.

The input filter 331 filters an input voltage received via an input terminal (Vin) to prevent an unnecessary electronic wave caused by high frequency switching from being radiated to the transformer 333. Here, the input filter 331 filters the unnecessary electronic wave using an inductor or a capacitor.

The transformer 333 applies the input voltage received from the input filter 331 to a primary coil under the control of the pulse width modulator 341. The input voltage applied to the primary coil is applied as energy of a secondary coil through a core. That is, under the control of the pulse width modulator 341, the transformer 333 adjusts a time for which the input voltage is applied to the primary coil, thereby controlling a magnitude of an output voltage.

Under the control of the DC-DC converter controller 339, the pulse width modulator 341 controls a time for which the input voltage is applied to the primary coil of the transformer 333. In detail, the pulse width modulator 341 controls a time for which the input voltage is applied to the primary coil of the transformer 333 depending on a square wave provided from the DC-DC converter controller 339. For example, depending on a square wave provided from the DC-DC converter controller 339, the pulse width modulator 341 controls and applies the input voltage to the primary coil of the transformer 333 when the square wave is a high value. On the other hand, the pulse width modulator 341 controls and does not apply the input voltage to the primary coil of the transformer 333 when the square wave is a low value.

The DC-DC converter controller 339 includes an internal oscillation circuit. If receiving an activation signal from the mode determiner 310, the DC-DC converter controller 339 outputs a square wave for controlling the pulse width modulator 341 at a frequency outputted from the internal oscillation circuit. The DC-DC converter controller 339 changes the frequency of the internal oscillation circuit depending on a magnitude of an output voltage provided from the output voltage detector 337 to output a stable voltage to the RF power amplifier. If changing the frequency, the DC-DC converter controller 339 controls a width of the square wave according to the changed frequency. For instance, if the output voltage is in a low state, the DC-DC converter controller 339 changes a frequency to step up the output voltage and controls the pulse width modulator 341 to increase a voltage supply time in the transformer 333. If the output voltage gets higher through the step-up, the DC-DC converter controller 339 changes the frequency and controls the pulse width modulator 341 to decrease the voltage supply time in the transformer 333.

The output rectifier and filter 335 generates, by a diode and a capacitor, a DC voltage using energy received from the transformer 333. In detail, the output rectifier and filter 335 rectifies, by the diode, energy received from the secondary coil of the transformer 333. After that, the output rectifier and filter 335 smoothes, by the capacitor, the rectified voltage and generates a DC voltage. Here, the diode should have a forward-current ability and be endurable to a reverse voltage, and the capacitor performs high-frequency noise elimination.

The output voltage detector 337 detects a voltage outputted from the output rectifier and filter 335 and provides the detected voltage to the DC-DC converter controller 339.

In an exemplary embodiment described above, the DC-DC converter 300 controls operation of the DC-DC module using the mode determiner 310 to reduce a range of voltage converted to optimize an operation characteristic of a corresponding electronic device. In detail, if the input voltage is higher or equal to an optimum voltage at which an operation characteristic of the RF power amplifier is optimized, the mode determiner 310 inactivates the DC-DC module 330 to pass the input voltage to the RF power amplifier. Also, if the input voltage is lower than the optimum voltage at which the operation characteristic of the RF power amplifier is optimized, the mode determiner 310 activates the DC-DC module 330 to step up the input voltage to the optimum voltage.

In another exemplary embodiment, a mode determiner 310 is positioned at a junction point between a bypass path and a DC-DC module 330 such that a DC-DC converter 300 selects a path of an input voltage according to a magnitude of the input voltage. Thus, the mode determiner 310 provides the input voltage to the bypass path when the input voltage is higher or equal to an optimum voltage at which an operation characteristic of an RF power amplifier is optimized. On the other hand, the mode determiner 310 provides the input voltage to the DC-DC module 330 when the input voltage is lower than the optimum voltage at which the operation characteristic of the RF power amplifier is optimized.

A process for the DC-DC converter to reduce a range of voltage converted by the DC-DC converter to optimize the operation characteristic of the RF power amplifier in the wireless communication system is described below.

FIG. 4 is a flow diagram illustrating a process of DC-DC conversion in a wireless communication system according to an exemplary embodiment of the present invention.

Referring to FIG. 4, the DC-DC converter identifies whether it receives an internal operation voltage of the RF power amplifier via the input terminal (Vin) in step 401.

Upon receiving the internal operation voltage, the DC-DC converter identifies a magnitude of the input voltage in step 403.

After that, the DC-DC converter compares the input voltage with a reference value in step 405. The reference value represents a magnitude of an optimum voltage at which an operation characteristic of the RF power amplifier is optimized.

The DC-DC converter provides the input voltage to the RF power amplifier in step 409 if the input voltage is higher or equal to the reference value (input voltage 3 reference value). That is, the DC-DC converter passes and provides the input voltage to the RF power amplifier.

On the other hand, if the input voltage is lower than the reference value (input voltage<reference value), the DC-DC converter steps up the input voltage to the reference value using the DC-DC module 330 in step 407. That is, the DC-DC converter steps up the input voltage to the optimum voltage at which the operation characteristic of the RF power amplifier is optimized. For example, in cases where a DC-DC module stepping up an input voltage has a construction of FIG. 3, the DC-DC converter controller 339 of the DC-DC module 330 changes a frequency and increases a time for which the input voltage is applied to the primary coil of the transformer 333 to perform step-up when an output voltage of the output rectifier and filter 335 is lower than the reference value. On the other hand, the DC-DC converter controller 339 changes the frequency and decreases a time for which the input voltage is applied to the primary coil of the transformer 333 when the output voltage of the output rectifier and filter 335 becomes higher or equal to the reference value through the step-up.

If the input voltage is stepped up, the DC-DC converter provides the step-up input voltage to the RF power amplifier in step 409.

After that, the DC-DC converter terminates the process.

As described above, the present invention has an advantage in which when a supply voltage is higher or equal to an optimum voltage of a specific electronic device, a DC-DC converter passes a supply voltage without any change and when the supply voltage is lower than the optimum voltage, the DC-DC converter steps up the supply voltage to the optimum voltage and provides the step-up supply voltage to the electronic device, thereby reducing a range of voltage converted by the DC-DC converter in a wireless communication system. Also, the present invention has an advantage in which the DC-DC converter performs only step-up and thus, achieving efficiency improvement in a supply voltage region and reducing a cost.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A Direct Current (DC)-DC converter in a wireless communication system, comprising:
a mode determiner for controlling operation of a DC-DC module depending on a magnitude of an input voltage;
the DC-DC module for, when activated by the mode determiner, stepping up the input voltage to a reference voltage and providing the step-up input voltage to a corresponding electronic device; and
a bypass module for, when the DC-DC module is inactivated by the mode determiner, passing the input voltage to the electronic device.

2. The converter of claim 1, wherein the mode determiner inactivates the DC-DC module when the input voltage is higher or equal to the reference voltage, and
wherein the mode determiner activates the DC-DC module when the input voltage is lower than the reference voltage.

3. The converter of claim 1, wherein the reference voltage is an optimum voltage at which an operation characteristic of the electronic device is optimized.

4. The converter of claim 1, wherein the DC-DC module comprises:
an input filter for filtering an unnecessary electronic wave of the input voltage;
a transformer for stepping up the input voltage filtered by the input filter up to the reference voltage under a control of a pulse width modulator;
an output rectifier and an output filter for rectifying and smoothing a voltage provided from the transformer and generating and outputting a DC voltage to the electronic device;
an output voltage detector for detecting a voltage outputted from the output rectifier and the output filter and providing the detected output voltage to a controller;
the controller for changing a frequency depending on a magnitude of the output voltage provided from the output voltage detector and generating a square wave according to the changed frequency; and
the pulse width modulator for controlling the transformer depending on the square wave provided from the controller.

5. The converter of claim 4, wherein the controller determines an operation state or a non-operation state of the DC-DC module under the control of the mode determiner.

6. The converter of claim 5, wherein the controller activates the DC-DC module when receiving an activation signal from the mode determiner, and
wherein the controller inactivates the DC-DC module when receiving an inactivation signal from the mode determiner.

7. The converter of claim 1, wherein the bypass module controls and does not let pass the input voltage when the DC-DC module is activated.

8. A Direct Current (DC)-DC converter in a wireless communication system, comprising:
a mode determiner for selecting a path for transmitting an input voltage to an electronic device depending on a magnitude of the input voltage;
a DC-DC module for, upon receiving the input voltage according to a selection of the mode determiner, stepping up the input voltage to a reference voltage and providing the step-up input voltage to the electronic device; and
a bypass module for, upon receiving the input voltage according to the selection of the mode determiner, passing the input voltage to the electronic device.

9. The converter of claim 8, wherein the mode determiner transmits the input voltage to the DC-DC module when the input voltage is higher or equal to the reference voltage, and
wherein the mode determiner transmits the input voltage to the bypass module when the input voltage is lower than the reference voltage.

10. The converter of claim 8, wherein the reference voltage is an optimum voltage at which an operation characteristic of the electronic device is optimized.

11. The converter of claim 8, wherein the DC-DC module comprises:
an input filter for filtering an unnecessary electronic wave of the input voltage;
a transformer for stepping up the input voltage filtered by the input filter to the reference voltage under a control of a pulse width modulator;
an output rectifier and an output filter for rectifying and smoothing the input voltage provided from the transformer and generating and outputting a DC voltage to the electronic device;
an output voltage detector for detecting a voltage outputted from the output rectifier and the output filter and providing the detected output voltage to a controller;
a controller for changing a frequency depending on a magnitude of the output voltage provided from the output voltage detector and generating a square wave according to the changed frequency; and
the pulse width modulator for controlling the transformer depending on the square wave provided from the controller.

12. A Direct Current (DC)-DC conversion method in a wireless communication system, the method comprising:
determining whether to convert an input voltage depending on a magnitude of the input voltage;
when the input voltage is converted, stepping up the input voltage to a reference voltage and providing the step-up input voltage to a corresponding electronic device; and
when the input voltage is not converted, passing the input voltage to the electronic device.

13. The method of claim 12, wherein the reference voltage is an optimum voltage at which an operation characteristic of the electronic device is optimized.

14. The method of claim 12, wherein determining whether to convert the input voltage comprises:
determining to convert the input voltage when the input voltage is lower than the reference voltage in magnitude; and
determining not to convert the input voltage when the input voltage is higher or equal to the reference voltage in magnitude.

15. The method of claim 12, wherein stepping up the input voltage comprises:
filtering an unnecessary electronic wave of the input voltage;
stepping up the filtered input voltage to the reference voltage; and
generating a DC voltage by rectifying and smoothing the step-up voltage and outputting the generated DC voltage to the electronic device.

16. The method of claim 15, further comprising:
identifying a magnitude of the output voltage;
changing a frequency of the output voltage depending on the magnitude of the output voltage and generating a square wave; and
generating a control signal for stepping up the input voltage depending on the square wave.

17. The method of claim 12, wherein determining whether to convert the input voltage comprises:
controlling and activating a DC-DC module for stepping up the input voltage to convert the input voltage when the input voltage is lower than the reference voltage in magnitude; and
controlling and inactivating the DC-DC module without converting the input voltage when the input voltage is higher or equal to the reference voltage in magnitude.

18. The method of claim 12, wherein determining whether to convert the input voltage comprises:
controlling and providing the input voltage to the DC-DC module for stepping up the input voltage to convert the input voltage when the input voltage is lower than the reference voltage in magnitude; and
controlling and providing the input voltage to a bypass module without converting the input voltage when the input voltage is higher or equal to the reference voltage in magnitude.
